(19) United States
(12) Patent Application Publication
(10) Pub. No.: US 2010/0178641 A1
(43) Pub. Date: Jul. 15, 2010

(54) Apparel fastening learning apparatus

(76) Inventor: David (Damon) Franklin, Queens Village, NY (US)

Correspondence Address: Brad M. Behar & Associates, PLLC, 94 Second Street, Mineola, NY, 11501, US

(21) Appl. No.: 12/319,661

(22) Filed: Jan. 12, 2009

(51) Int. Cl. G09B 19/24

(52) U.S. Cl. 434/260

(57) ABSTRACT

An apparel fastener learning apparatus for developing and disabled children, the mentally impaired, and the elderly is described that includes a first fastener plate having a plug and a second plate having a socket. The first plate has a predefined shape that is approximately identical to the shape of the second plate. The first plate includes a symbol that is in accordance with the shape of the fastener apparatus. In a first position, the first and second plates are snapped with the plug and the socket. In a second position, the first plate and the second plate are separated from each other. The first plate is snapped with only the second plate of the same fastener apparatus and not with a second plate of another fastener apparatus. In one embodiment, the fastener plates are securely coupled with apparels either by sewing along predefined holes or by using prongs.

### BACKGROUND OF THE INVENTION

1. Field of the Invention

The invention relates to teaching aids with apparel fastening buttons. In particular, the invention relates to teaching aids with apparel fasteners that provide a form of cognitive exercise and rehabilitation to children, mentally impaired individuals, and the elderly.

2. Description of Prior Art

Apparel fasteners such as buttons are well known in the art. Snap type buttons are widely used that includes a first top portion and a second receiving portion. The first portion is generally snapped in the second portion. Buttons are found on all types of apparel in various kinds of sizes and shapes. But they are generally ornamental and do not serve the function of button or fastener “matching” which ensures that each button, particularly “snap-type” buttons will only fit into the same “shaped” receiving “snap-type” end.

Efforts were made to develop teaching aids using various apparel fasteners. Attempts were also made to develop teaching aids to address the problem of matching correct buttons of apparel fasteners. Matching the proper buttons together is a problem that is not well addressed in the prior art. Furthermore, a user cannot wear some of the garment buttoning/fastening teaching aids in the art on a regular basis. U.S. Pat. No. 6,755,660 teaches a teaching aid using zippers, buttons, laces, snaps etc. But a user cannot wear apparel with these teaching devices. The teaching aid devices do not teach how to fasten correct fasteners together.

U.S. Pat. No. 6,991,465 teaches a method of facilitating childhood learning that includes fastening devices for apparel articles. However, this method doesn't address the problem of matching the correct buttons together and the user is not able to wear the apparel with the fastener or the teaching aid.

Some of the rehabilitation/teaching devices in the prior art are actually worn by the wearer or instructor to teach how to button and fasten together articles of clothes using popular methods such as buckling, buttoning, tying, strapping, etc. But it should be noted that they are not intended to be worn as regular apparel on a daily basis. In addition, they are not useful for children or disabled persons to teach various types of shapes and using the shapes to snap correct buttons/fasteners. For example, U.S. Pat. No. 6,151,715 discloses a training device that is in the form of an apron, however, the training device is worn as regular apparel on a daily basis and the fasteners are not intended to teach various types of shapes to the users.

Such devices are not worn on a regular basis to provide a constant exposure to the rehabilitation/teaching mechanisms. There also exist methods and techniques that teach and/or rehabilitate basic cognitive functions using color matching techniques and touch sensory identification. However, the problems of correct matching of fasteners, constant exposure to the teaching aid, and inability to teach types of shapes remain unresolved.

There is a need of a fastening apparatus that can be incorporated into any article of clothing and that can teach, maintain, and rehabilitate basic cognitive functions regarding basic shape identification, and color recognition. A fastening device for apparels is further needed that prevents mismatching of fasteners and that can act as a learning aid that provides a form of cognitive exercise and rehabilitation to mentally challenged individuals and the elderly.

### SUMMARY OF THE INVENTION

An apparel fastening apparatus is provided that is preferably incorporated into any article of clothing to teach, maintain and rehabilitate basic cognitive functions regarding basic shape identification, color recognition and tactile sensing for children, mentally impaired individuals, and the elderly as well as their caregivers.

The fastening apparatus includes a first fastener plate and a second fastener plate having predefined shapes and colors. The first fastener plate having a predefined shape and color includes a plug on a bottom portion of the first fastener.

The second fastener plate having a predefined shape and color includes a socket on a top portion of the second fastener.

The fastening apparatus has two positions. In a first position, the first and second fasteners are closed to snap with respective plug and socket along a predefined axis. In a second position, the first fastener and the second fastener are opened to separate from each other. The shape of the first fastener and the shape of the second fastener are preferably identical, for example, the first and the second fastener plates are triangular. The color of the first fastener and the second fastener are also similar.

The first and the second fasteners are preferably permanently coupled at predefined locations on the apparel. According to one embodiment, the first fastener and second fastener includes a plurality of equidistant through holes along their peripheries. In another embodiment, the first and second fastener plates are mounted at respective locations on the apparel with respective prongs.

In this embodiment, a top portion of the first fastener plate defines a hole that receives prongs to mount the first fastener on apparel. Similarly, a bottom portion of the second fastener plate defines a hole that receives prongs to mount the second fastener on the article of clothing. In another embodiment, the top portion of the first plate includes a raised letter. The raised letter relates to the first letter of the spelling of the shape of the first plate.

The fastening apparatus is advantageously useful to teach, maintain and rehabilitate basic cognitive functions regarding basic shape identification, and color recognition for disabled individuals, children, and elder individuals.

### BRIEF DESCRIPTION OF THE FIGURES

FIG. 1 is a top perspective view of a fastener apparatus of the present invention in a first closed position;

FIG. 2 is a top perspective view of the fastener apparatus of FIG. 1 in a second opened position;

FIG. 3 is a front perspective of the fastener apparatus of FIG. 1 in the second position that shows a plug of a first fastener and a socket of a second fastener;

FIG. 4 is a top view of a shirt with a plurality of fasteners in accordance with the present invention;

FIG. 5 is a top perspective of fasteners having raised symbols according to a first embodiment of the present invention;

FIG. 6 is an exploded view of a second embodiment of fastener apparatus of FIG. 1; and

FIG. 7 is an exploded view of a third embodiment of the fastener apparatus of FIG. 1.

### DETAILED DESCRIPTION OF THE INVENTION

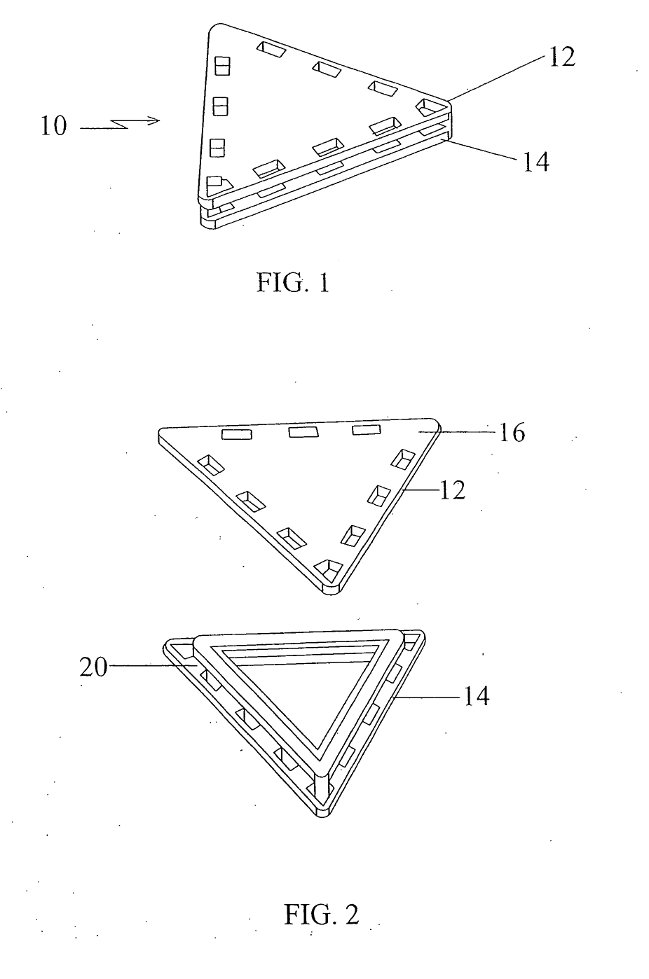

Referring to FIG. 1, a preferred embodiment of a fastening apparatus of the present invention is shown. The fastening apparatus or an apparel fastener 10 includes a first fastener plate 12 and a second fastener plate 14 having predefined shapes. The plates 12 and 14 are preferably securely positioned on predefined apparel at predefined locations. The fastening apparatus 10 has at least two positions. In a first closed position, first fastener 12 and second fastener 14 are snapped together. In a second opened position, first fastener 12 and second fastener 14 are separated or disassembled from each other.

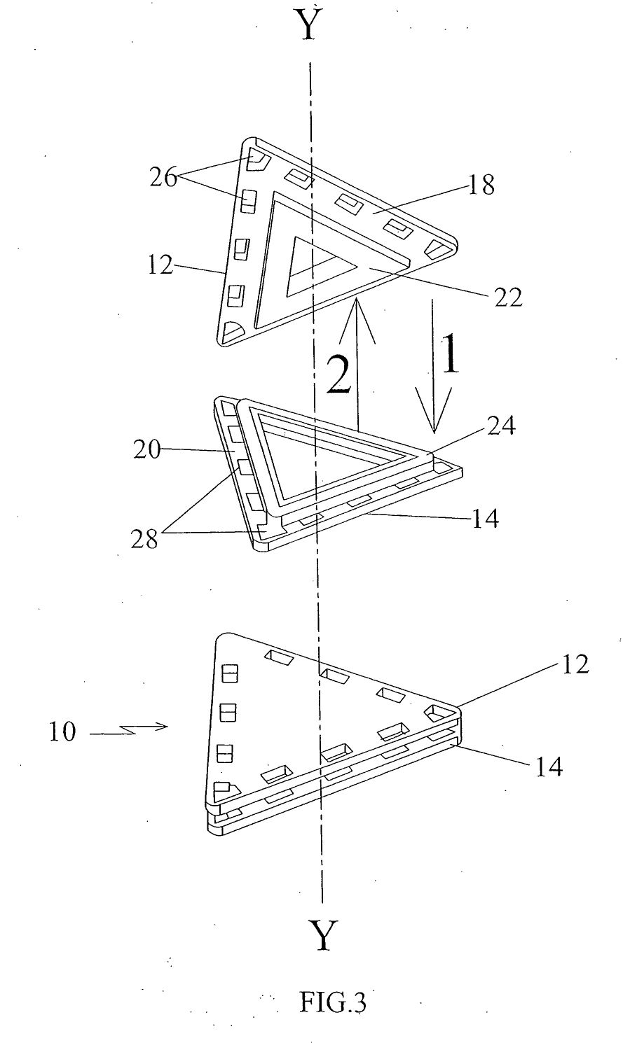

Referring to FIGS. 2 and 3, first fastener 12 includes a top side 16 and a bottom side 18. Second fastener 14 also has a top side 20 and a bottom side. Bottom side 18 of first plate 12 includes geometrically shaped plug 22 and top side 20 of second fastener plate 14 include geometrically shaped socket 24. The plug 22 and the socket 24 are designed to assemble fasteners 12 and 14 with a snap fit. First fastener 12 includes a plurality of predefined through holes 26 along a periphery of first fastener 12. Second fastener 14 also includes a plurality of predefined through holes 28 along a periphery of second fastener 14.

In the first position, first fastener 12 and second fastener 14 are snapped to define the fastening apparatus 10. According to one preferred method, first plate 12 is snapped with second plate 14 by moving first plate 12 approximately along axis-Y preferably in a direction indicated by arrow 1. In the second position, first fastener 12 and second fastener 14 are separated from each other along axis-Y as indicated by arrow 2. The shape of plug 22 and shape of socket 24 are defined to snap first plate 12 and second plate 14 along the axis-Y as indicated by arrow 1. The shape of the first fastener 12 and the second fastener 14 is approximately identical. The fasteners 12 and 14 preferably have the same color. For example, a first fastener and a second fastener of the fastening apparatus 10, in accordance with the present invention, are triangular in shape and have green color.

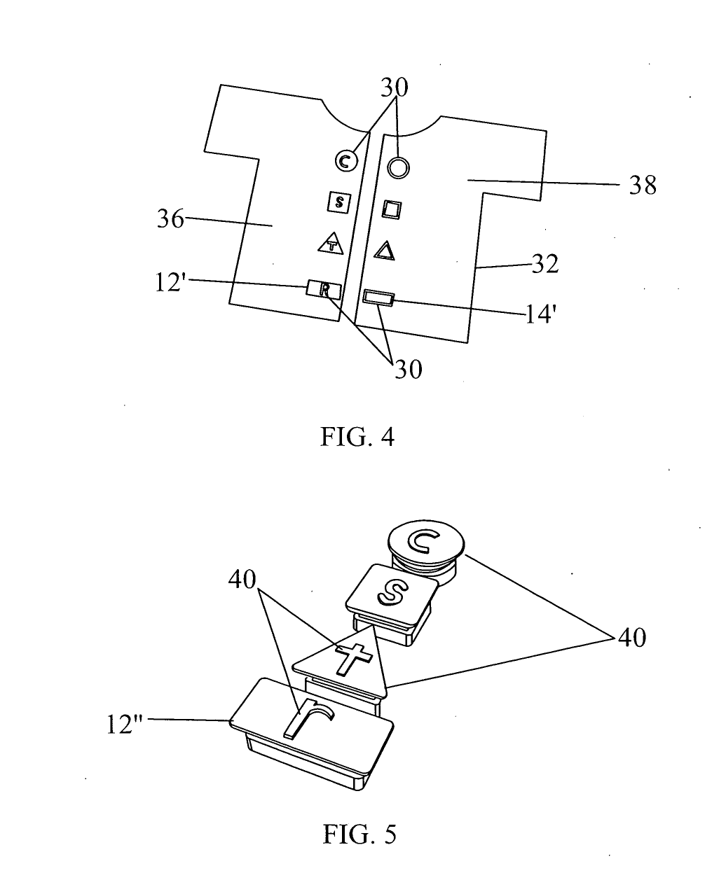

As shown in FIG. 4, fasteners 30 are securely mounted on a shirt 32 at predefined positions. Each of the first fasteners 12 is mounted on a first part 36 of shirt 32 and each of the second fasteners 14 is securely mounted on a second part 38 of the shirt 32. Each of first fasteners 12′ and 14′ of the fastening apparatuses 30 has a predefined shape, and the plates 12′ and 14′ are preferably secured to a fiber of the apparel 32 by sewing. Any two respective fastener plates 12′ and 14′ of any of the fastening apparatuses 30 preferably have the same color, for example, the first fastener plate 12′ and the second fastener plate 14′ belonging to one apparatus are green colored. Through holes 26 and 28 (See FIG. 3) along the periphery of the respective fastener plates are preferably employed for sewing the respective fasteners 12 and 14.

First fastener plate 12′ and second fastener plate 14′ of each of the fasteners 30 is positioned on the shirt 32 so that the shape of a fastener plate on the first side 36 of the shirt 32 indicates the appropriate fastener plate on the second side 38 of the shirt 32. The shape and color of a fastener plate on first side 36 matches with a shape and color on an appropriate fastener plate on the second side 38. For example, a circular red plate on the first part 36 indicates that matching plate on the second side 38 is a circular red plate.

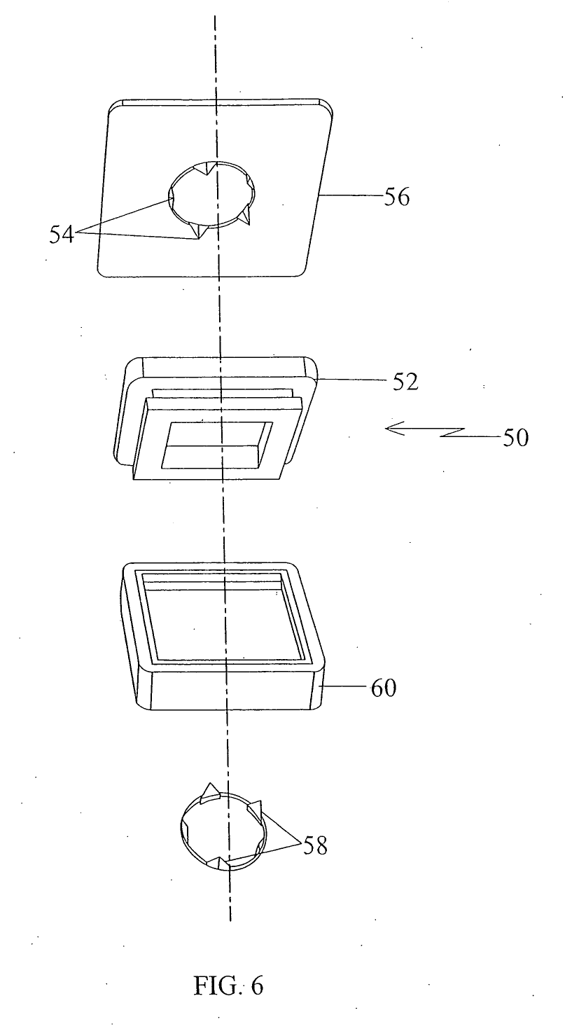

Referring to FIG. 5, a first embodiment in accordance with the present invention is shown. Each of the fasteners 40 is in the first snapped position. Each first fastener plate 12″ includes at least one predefined raised symbol 40, for example, an alphabet, numeric letter, Greek symbol, spiritual symbol, on the respective first side. The symbol 40 is preferably centrally positioned on the top side 16 of first plate 12″.

The fastener apparatus 10 according to the preferred embodiment is preferably shaped in various forms, for example, triangle, square, rectangle, circle etc. The raised symbol 40 reflects a first letter of the spelling of the shape of the fastener apparatus 40. For example, the letter ‘C’ on a circular fastening apparatus stands for circle, letter ‘S’ stands for a square, letter ‘T’ stands for a triangle, letter ‘R’ stands for a rectangle.

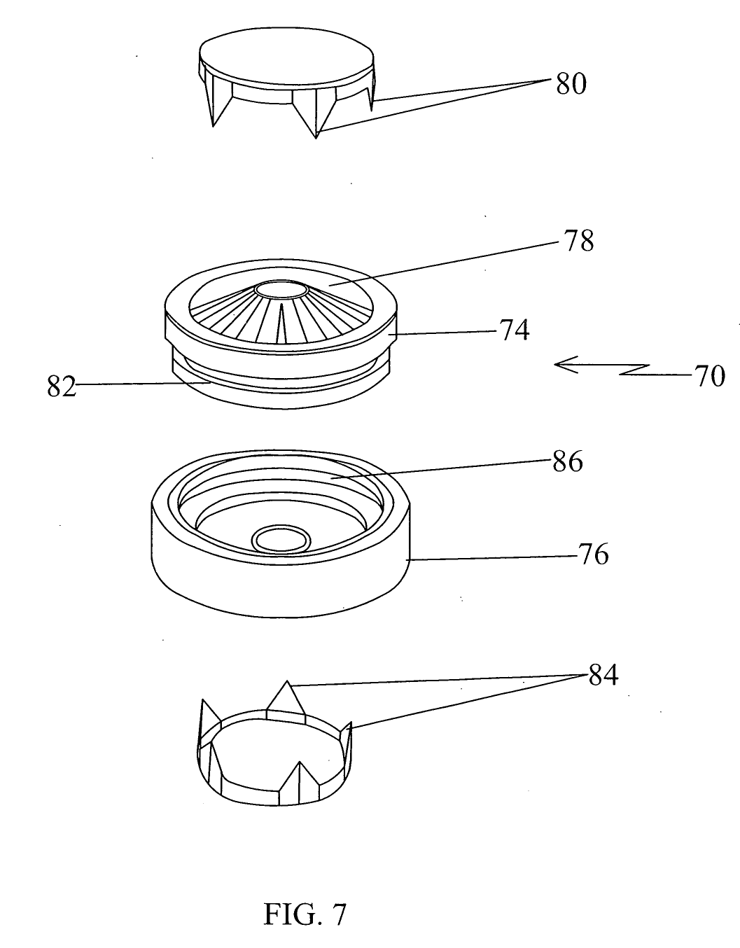

Referring to FIG. 6, a second embodiment of the fastening apparatus 10 in accordance with the present invention is described. In this one embodiment 50, a top side of a first fastener plate 52 includes a hole that securely receives fabric prongs 54. The fabric prongs 54 are preferably coupled on an attachment plate 56 that is approximately similar shape as that of the first plate 52. The fabric attachment prongs 54 are securely coupled with the attachment plate 56 with known techniques in the art, for example, a press fit, riveting, or permanent pasting.

The hole on the top side of the first fastener plate 52 is in accordance with the shape of the fabric prongs 54. First fastener plate 52 is securely coupled on apparel with prongs 54. Prongs 58 are received in predefined holds on a bottom side of the second plate 60. The second plate 60 is securely mountable on apparel with respective prongs 58. The fasteners 52 and 60 are securely mounted at predefined locations on apparel with respective prongs 54 and 58. The fastening apparatus has a first closed position and a second opened position.

Now referring to FIG. 7, another embodiment of the fastener apparatus is shown. In this embodiment, the fastener apparatus 70 includes a first fastener plate 74 and a second fastener plate 76. A top portion of first plate 74 defines a hole 78 that receives prongs 80. In this embodiment, the first plate 74 includes a geometrically shaped plug 82 on a bottom side of first plate 74. A bottom side of the second plate 76 defines a hole that receives prongs 84. The second plate 76 defines a geometrically shaped socket 86 on a top portion of the second plate 76.

In the first position, plug 82 of the first plate 74 and the socket 86 of the second plate 76 are assembled. The plug 82 is snapped in the socket 86 to close the fastener 70 in the first position. In the second position, plates 74 and 76 are separated from each other. Prongs 80 securely hold the first plate 74 to apparel at a predefined location. Prongs 84 securely hold the second plate 76 to the apparel at a predefined location.

Now referring to FIGS. 1 to 7, in operation, a plurality of fastening apparatus 10 are mounted on predefined locations of apparel, for example, a shirt. A first fastener plate and second plate of each of the fasteners 10 are mounted on a shirt or any apparel either by sewing along the peripheral holes 26 and 28 or with the fabric attachment prongs 80 and 84.

The user identifies the shapes and color of all fasteners. The user tries to snap the similar shaped fasteners together to snap a fastener 10. The user understands that the fasteners having difference shapes can't be snapped together. For, example in case of a fastener with a raised letter C. The user determines that the fastening plate with a letter ‘C’ can be snapped with only a circular fastener. The fastener 10 can be incorporated into any article of clothing to teach, maintain and rehabilitate basic cognitive functions regarding basic shape identification, color recognition and tactile sensing.

A fastener plate of one portion of a shirt matches with only one predefined plate on the other part of the shirt. The shapes of the matching plates are also approximately identical. The predefined shapes of the fastener plates prevents the mismatching when children, mentally impaired, or elderly persons are dressing or are being dressed by their caregivers. The predefined shapes of plug 22 and socket 24 of respective fastener plates ensure that only similarly shaped plugs and sockets are advantageously snapped together. In case of a first plate with a raised letter, the user understands that the raised letter indicates a first letter of the shape spelling. This feature is very important when children, mentally disabled persons are dressing. This is also helpful for elderly persons.

An instructor or a care taker need not wear a shirt or apparel with fasteners to teach the snapping technique. The instructor can show the similarity of shapes feature to the children. Other advantages of the fastener apparatus include development understanding of the shapes, and understanding associativity of shapes with a particular letter. The apparel fastener apparatus of the present invention is useful to teach various shapes to normal children. The fasteners 10 of the present invention are useful to teach snapping technique of the buttons of apparel to disabled children. The invention provides the ability to parents and caregivers to correctly match the fasteners together on articles of clothing even in low-light settings

The present invention is an important teaching aid to improve understanding of color and color matching. The apparatus is also useful to teach hand eye coordination. While developing the ability to correctly match the fasteners together on an article of clothing the present invention also teaches fundamental principles of various types of shapes. To learn shapes while dressing is an enjoyable experience for children.

An aspect of cognitive maintenance that aids in maintaining healthy brain functions is one of the improvements and functions of the snapping apparatus 10, for the elderly or aging individuals. The snapping apparatus also imparts the ability to correctly match the fasteners together on articles of clothing to aging individuals. The present invention is an aid for cognitive rehabilitation for mentally impaired individuals to re-associate themselves with basic shape identification, color recognition, and tactile sensory restoration using the present invention.

Although the present invention has been described in terms of the preferred embodiment above, numerous modifications and/or additions to the above described preferred embodiments would be readily apparent to one skilled in the art. It is intended that the scope of present invention extends to all such modifications and/or additions and that the scope of present invention is limited by the claims set forth below.

1. An apparel fastening apparatus that is incorporated into any article of clothing to teach, maintain and rehabilitate basic cognitive functions regarding basic shape identification, and color recognition for disabled individuals comprising:
a first fastener plate, the first fastener plate having a predefined shape and color including a plug on a bottom portion of the first fastener;
a second fastener plate, the second fastener plate having a predefined shape and color including a socket on a top portion of the second fastener;
a first position of the fastening apparatus, in the first position, the first plate having the predefined shape and color, and the second plate having a predefined shape and color, are closed to snap with respective plug and socket along a predefined axis;
a second position of the fastening apparatus, in the second position, the first fastener and the second fastener are opened to separate from each other.

2. The fastening apparatus of claim 1, wherein the shape of the first fastener and the shape of the second fastener are identical.

3. The fastening apparatus of claim 1, wherein the color of the first fastener and the shape of the second fastener are similar.

4. The fastening apparatus of claim 1, wherein the first fastener includes a plurality of equidistant through holes along a periphery of the first fastener.

5. The fastening apparatus of claim 1, wherein the second fastener plate includes a plurality of equidistant through holes along a periphery of the first fastener.

6. The fastening apparatus of claim 1, wherein the top portion of the first plate includes a raised letter.

7. The fastening apparatus of claim 6, wherein the raised letter relates to the first letter of the spelling of the shape of the first plate.

8. The fastening apparatus of claim 1, wherein the top side of the first fastener plate defines a hole that receives prongs to mount the first fastener on apparel.

9. The fastening apparatus of claim 1, wherein the bottom side of the second fastener plate defines a hole that receives prongs to mount the second fastener on apparel.
